(19) United States
(12) Patent Application Publication
(10) Pub. No.: US 2017/0355447 A1
(43) Pub. Date: Dec. 14, 2017

(54) Thrust-Dependent Variable Blade Pitch Propeller

(71) Applicant: GoPro, Inc., San Mateo, CA (US)

(72) Inventors: Bruno Cesar Douady-Pleven, Gif-sur-Yvette (FR); Gary Fong, Cupertino, CA (US)

(21) Appl. No.: 15/618,700

(22) Filed: Jun. 9, 2017

Related U.S. Application Data
(60) Provisional application No. 62/348,693, filed on Jun. 10, 2016.

(51) Int. Cl. B64C 11/34

(52) U.S. Cl. CPC B64C 11/343; B64C 11/346

(57) ABSTRACT

An offset blade of a propeller varies the blade pitch according to in-flight conditions in order to maximize the performance and efficiency of the propeller. As the propeller begins to rotate, upward thrust forces and lateral centrifugal forces are generated on the blade. The balance between the thrust and centrifugal forces determines the blade pitch. At rest, the blade pitch is minimized whereas when in-flight, the blade pitch of the propeller blade is maximized. The blade is coupled with a rotor hub through a connector that determines the maximum and minimum blade pitches of the blade. Furthermore, the connector reduces blade pitch oscillations that often occur in flight.

### CROSS REFERENCE TO RELATED APPLICATIONS

This application claims a benefit of U.S. Provisional Patent Application No. 62/348,693, filed Jun. 10, 2016, the content of which is incorporated by reference in its entirety.

### TECHNICAL FIELD

This disclosure relates to the design of a blade of a propeller, and more specifically, to a blade system that changes the blade pitch in different flight conditions.

### BACKGROUND

Aerial vehicles such as quadcopters or airplanes may be reliant on the blade of a propeller to liftoff, hover, and directionally fly. Fixed pitch blades are only designed to be maximally efficient at one particular flight condition. Therefore, the efficiency of the fixed pitch propeller suffers during significant portions of flight. Blades that are able to vary the blade pitch are conventionally controlled through mechanical systems that require the input of a pilot. Instead of being efficient at only one flight condition, the propeller may be controlled to be increasingly efficient during many different conditions. However, these mechanical systems are prone to inaccuracies, mechanical failure, and/or human error. Additional mechanisms for auto-adjusting blade pitches focus on maintaining propeller blade speed as the aerial vehicle is in flight. However, these automated mechanisms are also expensive and lacking in reliability.

### BRIEF DESCRIPTIONS OF THE DRAWINGS

The disclosed embodiments have other advantages and features which will be more readily apparent from the following detailed description and the appended claims, when taken in conjunction with the accompanying drawings, in which:

Figure (FIG. 1 illustrates a propeller with offset blades, in accordance with an example embodiment.

FIG. 2 illustrates an airfoil cross-section of the blade attached to a rotor hub, in accordance with an example embodiment.

FIG. 3 illustrates a top view of a blade with counterweights, in accordance with an example embodiment.

FIGS. 4A and 4B illustrate a blade connector and an airfoil cross-section, respectively, at rest, in accordance with an example embodiment.

FIGS. 4C and 4D illustrate a blade connector and an airfoil cross-section, respectively, while in-flight, in accordance with an example embodiment.

FIGS. 5A and 5B illustrate cross-sectional views of a ball bearing blade connector, in accordance with an example embodiment.

FIG. 6A illustrates a fluid filled connector, in accordance with an example embodiment.

FIG. 6B illustrates a top view of a ball bearing blade-hub connector, in accordance with an example embodiment.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview Configuration

Disclosed by way of example embodiments is a propeller having a blade structured to alter the blade pitch depending on the amount of generated thrust that is exerted on the blade while in-flight. The propeller is for use with rotary winged aerial vehicles, e.g., quadcopters, airplanes. For ease of discussion, the embodiments herein will be described with respect to quadcopters.

The blade is designed to have an offset from its connection to a rotor hub. At rest, the blade of the propeller can be oriented with an initial blade pitch. In some embodiments, the initial blade pitch is the minimum blade pitch. Therefore, as the blade is put into rotational motion, the blade 130 with the initial blade pitch can generate thrust forces that cause the aerial vehicle to lift off of the ground. Additionally, the generated thrust forces imparted on the blade also generate a corresponding rotational torque on the blade. This torque causes the blade pitch to change towards a second blade pitch. In various embodiments, the second blade pitch is the maximum blade pitch of the blade 130. In turn, this maximizes the efficiency of the blade. In addition to improving the efficiency of the blade, the variable blade pitch that depends on generated thrust may be achieved in-flight without the need for human input, thereby minimizing errors (e.g., human or mechanical) that often accompanies conventional mechanical control systems.

### Example Blade

Referring now to Figure (FIG. 1, it illustrates an offset propeller 100 viewed from a top-down perspective, in accordance with an example embodiment. In one embodiment, the propeller 100 may comprise two opposing blades of the propeller (or blades) 130, each blade 130 coupled via a connector 115 to an extension 160 of a rotor hub 150. In some embodiments, the connector 115 is a part of the blade 130 such that the body of the blade 130 is connected to the rotor hub 150 through the connector 115. Each blade 130 has a root 120 of the blade 130 nearest to the connector 115, and a tip 125 of the blade 130 farthest from the connector 115. The distance between the root 120 and the tip 125 may be referenced as the radius of the blade 130. In various embodiments, the blade 130 is offset with an offset distance 140 relative to the rotor hub 150. In various embodiments, the connector 115 of the blade 130 is aligned with the rotor hub 150 and the offset distance 140 represents the offset between the connector 115 of the blade 130 and the body of the propeller blade 130. The offset distance 140 enables the generation of torque on the blade 130 when thrust forces are imparted on the blade 130.

In various example embodiments, a portion of the extension 160 of the rotor hub 150 is surrounded by the connector 115. Additionally, the extension 160 may have a channel path 110 that has a first end 112 and a second end 114. For example, as depicted in FIG. 1, a portion of the extension 160 that includes the channel path 110 is encompassed by the connector 115.

The channel path 110 may be located on the surface of the extension 160. In one example embodiment, the cross-section of the extension 160 is circular and the channel path 110 travels along the circumference of the extension 160. To enable the connector 115 to couple with the extension 160, the connector 115 may have a reciprocal protrusion that, when coupled, substantially aligns with the channel path 110 of the extension 160. In one embodiment, the channel path 110 and the reciprocal protrusion of the connector 115 are threaded, and therefore, can couple with one another. The connector 115 of the blade 130 may be rotated in a clockwise or counter-clockwise manner along the channel path 110 to achieve different blade pitches.

In one embodiment, the channel path 110 resides on a portion of the surface of the extension 160. For example, if the extension 160 is circular, a first end 112 of the channel path 110 may be located at a first position on the surface of the extension 160 whereas the second end 114 of the channel path 110 may be located at a second position on the surface of the extension 160 such that the channel path 110 does not traverse the full 360 degrees (e.g., without traversing the perimeter) of the cylindrical extension 160. In various embodiments, the channel path 110 traverses the perimeter of the cylindrical extension 160 multiple times (e.g., such as a threaded bolt and nut combination).

In various embodiments, the first end 112 and second end 114 of the channel path 110 may be located on the extension 160 to correspond to the maximum and minimum blade pitch of the propeller blade 130, respectively, when the connector 115 is coupled to the first end 112 and second end 114. Therefore, in some embodiments, the first end 112 and second end 114 of the channel path 110 on the extension 160 may differ by up to 40 degrees along the perimeter of the cylindrical extension 160. In other embodiments, the first end 112 and second end 114 of the channel path 110 on the extension 160 may differ by up to 20 degrees along the perimeter of the cylindrical extension 160.

Therefore, the connector 115 (and the blade 130) may be rotated along the channel path 110 and held at the first end 112 where the blade 130 achieves the maximum blade pitch. Alternatively, the connector 115 (and the blade 130) may be rotated in an opposite direction along the channel path 110 and held at the second end 114 where the blade 130 achieves a minimum blade pitch. In some embodiments, given that the channel path 110 terminates at the first end 112 and the second end 114, the propeller blade 130 is unable to continue increasing or decreasing its blade pitch once the connector 115 is rotated to the first end 112 and second end 114, respectively. Therefore, the blade 130 is held at the maximum and minimum blade pitch. In some embodiments, the first 112 and second end 114 along the channel path 110 are set by detents or structures located on the extension 160 of the rotor hub 150. In other words, the detents or structures located on the extension 160 may define the maximum and minimum blade pitch.

As depicted in FIG. 1, the channel path 110 may be oriented such that a first end 112 of the channel path 110 is distal to the rotor hub 150 in comparison to a second end 114 of the channel path 110 that is located proximal to the rotor hub 150. In various embodiments, the first end 112 of the channel path 110 corresponds to the coupling point between the connector 115 and the channel path 110 such that the propeller blade 130 has a maximum blade pitch. Additionally, the second end 114 of the channel path 110 corresponds to the coupling point between the connector 115 and the channel path 110 such that the propeller blade 130 has a minimum blade pitch.

In various embodiments, the channel path 110 may have a particular geometry (e.g., linear) along the extension 160 of the rotor hub 150. For example, the channel path 110 between the first end 112 and the second end 114 may follow one of a linear, polynomial, logarithmic, or exponential curve. The geometry of the channel path 110 may be designed such that a desired rate of change of the blade pitch can be achieved as the connector 115 rotates along the channel path 110 between the first end 112 and the second end 114.

In some embodiments, the channel path 110 need not be a particular design located on a surface of the extension 160. For example, the channel path 110 and connector 115 may be together embodied as one or more helicoidal wires. In other words, each helicoidal wire may be coupled to the extension 160 of the rotor hub 150 whereas a second end of the helicoidal wire may be coupled to the propeller blade 130. The one or more helicoidal wires may be either left or right handed helices. In one embodiment, the helicoidal wire aids in maintaining the blade pitch of the propeller blade 130 at an initial blade pitch (e.g., minimum blade pitch).

In various embodiments, the extension 160 of the rotor hub 150 may be composed of stainless steel whereas the connector 115 of the blade 130 may be composed of nylon. Additionally, the surfaces of the channel path 110 of the extension 160 and the reciprocal protrusion of the connector 115 may be coated with a polymer or substance that may increase or decrease the coefficient of friction between the two surfaces. This may increase or decrease the overall torque required to rotate the connector 115 relative to the extension 160.

Even though FIG. 1 depicts two separate blades 130, in some embodiments, the propeller may include three, four, or more blades 130 coupled to the rotor hub 150 via the connector 115. It is noted that although the structural elements of the propeller 100 have been individually identified, the propeller 100 may be either comprised of one of more of the elements fit together, e.g., via adhesives and/or mechanical connectors, or may be a unibody construction.

The airfoil, which is a cross-section at a particular point along the blade 130, may have significantly different designs depending on its location along the radius of the blade. For example, an airfoil at the root 120 of the blade 130 may have a significantly different composition than an airfoil at the tip 125 of the blade. In some embodiments, the blade 130 is designed with a particular twist along the length of the blade 130. The blade twist is the change in blade pitch proceeding along the radius of the blade from the root 120 to the tip 125. Given that lift increases quadratically with the rotational velocity of the blade 130, the tip 125 of the blade 130 experiences significantly higher quantities of thrust as compared to the root 120 of the blade 130, especially at higher rotational velocities. Therefore, the blade twist may be designed to provide proportionate amounts of lift across the radius of the blade. In some embodiments, the root 120 of the blade 130 may have the highest blade pitch whereas the tip 125 of the blade 130 possesses the lowest blade pitch. In other embodiments, other designs of the twist of a blade 130 can be implemented.

### Forces Applied to a Blade

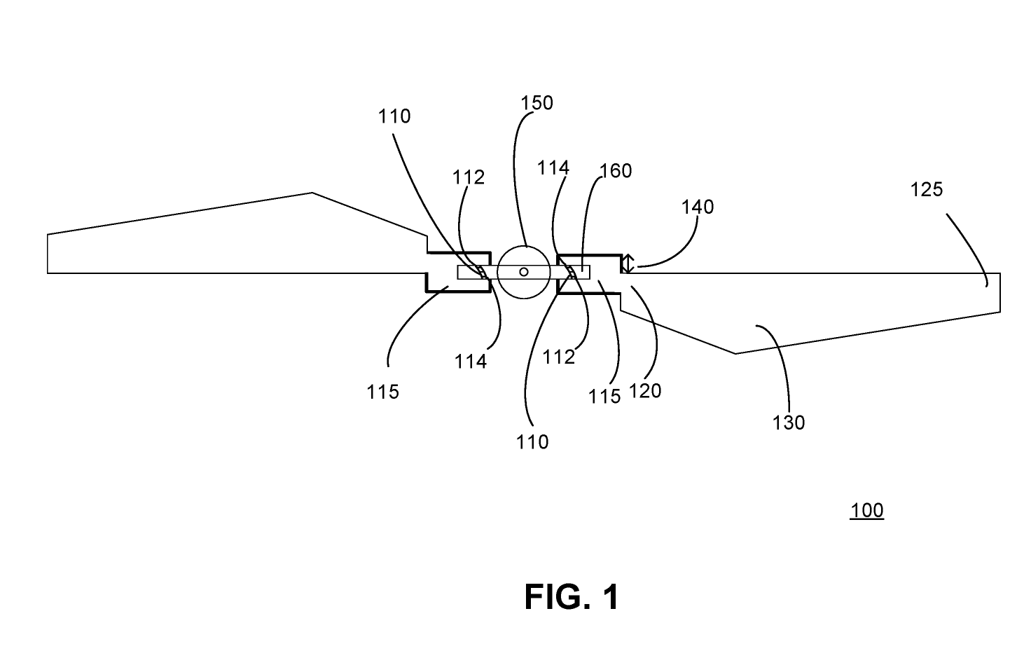

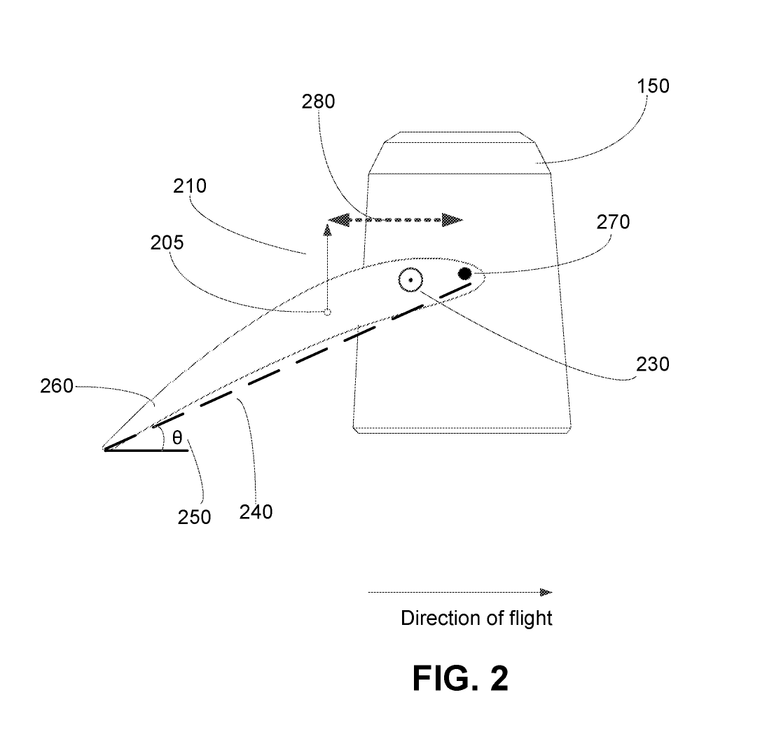

Turning now to FIG. 2, it illustrates an airfoil cross-section 260 of the blade 130 attached to a rotor hub 150, in accordance with an example embodiment. This example embodiment may depict the airfoil cross-section 260 near the halfway point between the root 120 and tip 125 of the blade 130. The connection between the blade 130 and the rotor hub 150 (e.g. where the connector 115 and the extension 160 are coupled) is depicted at location 270. Further illustrated are the intrinsic characteristics of the airfoil cross-section including a chord line 240 of the blade 130 and a blade pitch (0) 250. Although FIG. 2 depicts a particular example design of the airfoil cross-section 260, one skilled in the art may envision a variety of different airfoil shapes. This may include varying intrinsic parameters of the airfoil including the camber, maximum camber length, thickness, maximum thickness, and chord length.

As currently illustrated in FIG. 2, the airfoil may have a blade pitch of θ 250. In some embodiments, the blade 130 has a blade pitch of θ 250 at rest. As the blade 130 begins to increase in rotational velocity, the blade pitch increases. In various embodiments, the blade pitch of the blade 130 may be between a maximum blade pitch of 20 degrees and a minimum blade pitch of 1-2 degrees. The blade root 120, blade tip 125 (and other portions of the blade 130) may have different blade pitch ranges.

Also depicted in FIG. 2 is the centrifugal force 230 applied on the blade 130 in a direction away from the rotor hub 150 (i.e. out of the page as illustrated in FIG. 2). The centrifugal force 230 causes the connector 115 of the blade 130 to move laterally away from the rotor hub 150 relative to the extension 160 of the rotor hub 150. The lateral centrifugal force 230 may cause a torque on the blade 130 that acts in the counter-clockwise direction, the torque stemming from the channel path 110 of the extension 160 as it guides the connector 115. Specifically, as discussed above in regards to FIG. 1, given that the first end 112 of the channel path 110 is located distal to the rotor hub 150 in comparison to the second end 114 of the channel path 110, the lateral centrifugal force 230 causes the connector 115 to rotate towards the first end 112 of the channel path 110. In other words, the torque from the centrifugal force 230 causes the propeller blade 130 to rotate in a counter-clockwise manner and to increase blade pitch 250 of the blade 130. Altogether, increasing centrifugal force 230 results in a counter-clockwise torque on the blade that increases the blade pitch 250.

Additionally, the generated thrust 210 is applied at the center of thrust 205 of the airfoil cross-section 260. The generated thrust 210 forces are depicted as acting in a vertical direction. However, it may be appreciated that the generated thrust 210 force may also include a horizontal force component. Given that the blade 130 is rotatably coupled to the rotor hub 150 and offset by an offset distance 140, the generated thrust 210 provides a torque on the blade 130 around the connection 270. FIG. 2 further depicts the lever arm of the generated thrust 210, hereafter referred to as R₁ 280. The distance of the lever arm R₁ 280 can be tailored by the offset distance 140 between the connector 115 and the body of the propeller blade 130. In various embodiments, the distance R₁ may be around 20 millimeters. One skilled in the art can appreciate that the blade 130 may be designed so the location of the center of thrust 210 may be different by varying the characteristics of the blade such as the blade camber.

The torque, τ, generated on each airfoil cross-section 260 by the thrust force 210 may be calculated as

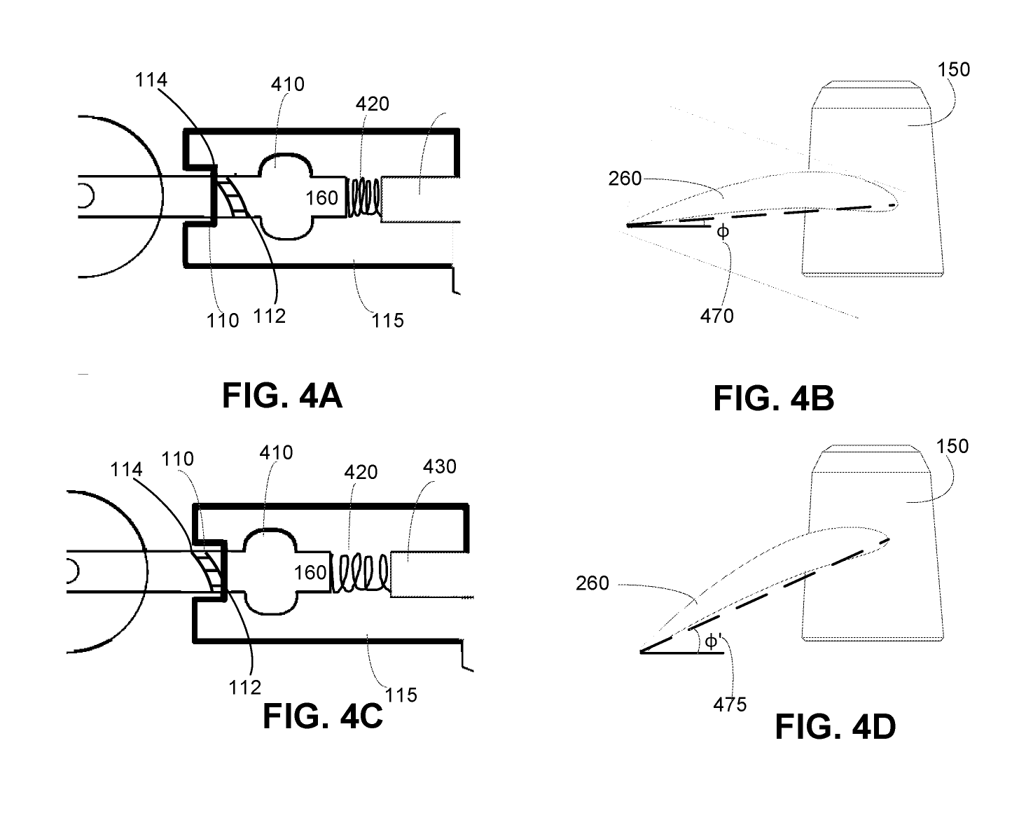

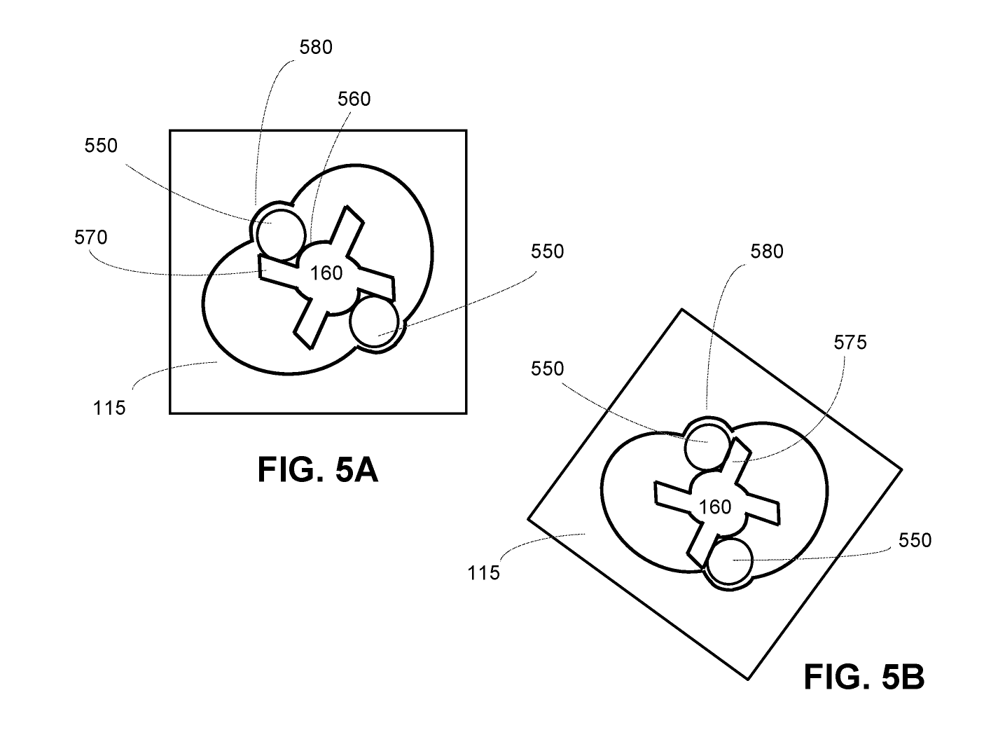

τ=T*R₁

where T is the generated thrust 210 on each airfoil cross-section 260. This equation assumes that positive torque occurs in the clockwise direction. The overall torque on the blade 130 may be calculated by summating the individual torque on each airfoil cross-section 260 across all airfoil cross-sections. At rest (e.g. before takeoff), the blade pitch may be held at an initial position by components in the connector 115 which will be discussed in FIGS. 4 and 5. As the generated thrust 210 increases, the corresponding torque is positive (e.g. clockwise). Therefore, the generated thrust 210 on the offset blade 130 causes a clockwise rotation of the blade 130.

The torque deriving from the centrifugal force 230 (causing a counter-clockwise blade rotation) and the torque due to the generated thrust 210 (causing a clockwise blade rotation) oppose each other and determine the overall blade pitch 250 of the blade 130 while in flight. The magnitude of the generated thrust 210 is proportional to an incidence angle (i) and the square of the rotational velocity of the blade 130. The magnitude of the centrifugal force 230 is also proportional to the square of the rotational velocity of the blade 130. Therefore, as both forces scale as the square of the velocity, the ratio between the two forces remain independent of the rotational velocity of the blade 130. The coupled connector 115 of the blade 130 and extension 160 of the rotor hub 150 may be designed so that the torque balance between the centrifugal force 230 and the generated thrust 210 remains a constant ratio. In other words, the torque balance remains independent of the rotational speed of a propeller blade 130.

In various embodiments, an additional force on the propeller blade 130 that derives from a front wind may affect the blade pitch of a propeller blade 130. For example, while in flight, the aerial vehicle (and the propeller blades 130) may experience the front wind, which refers to incoming wind that opposes the direction in which the aerial vehicle is flying. In various embodiments, the front wind may affect the generated thrust force 210 on a propeller blade 130; however, the front wind may not affect the centrifugal force 230 on a propeller blade 130. Therefore, the front wind may alter the balance of torques that derive from the thrust force and the centrifugal force and thereby cause the propeller blade 130 to change its blade pitch. As a note, when an aerial vehicle is taking off, landing, or hovering, the front wind may be minimal because forward movement of the aerial vehicle may be minimal. Therefore, the force imparted on the propeller blade 130 due to the front wind may be minimal when taking off, landing, or hovering.

When the aerial vehicle is traveling at a forward velocity, the body of the aerial vehicle may be oriented forward (e.g., downward relative to the horizon). Therefore, a front wind on the propeller blade 130 may be in an opposite direction of a component of the thrust force 210. In some scenarios, the front wind directly opposes the thrust force 210 itself. In other words, the front wind reduces the thrust force 210 relative to the centrifugal force 230, thereby enabling the propeller blade 130 to rotate counter-clockwise (e.g., due to larger torque from centrifugal force 230) and increase the blade pitch.

As the aerial vehicle increases in forward velocity, the front wind experienced by the aerial vehicle (and the propeller blades 130) may increase. In various embodiments, the angle of incidence for a propeller blade 130 changes as the forward velocity changes. For example, the angle of incidence may be the angle between the chord line 240 (see FIG. 2) of the propeller blade 130 and the relative direction of a combined flow of air (e.g., due to both the front wind and rotational wind experienced by the propeller blade 130 as it rotates). In various embodiments, an increase in the forward velocity would cause a corresponding decrease in the angle of incidence. Therefore, as the forward velocity increases, the blade pitch of the propeller blade 130 is increased in order to maintain the angle of incidence. In other words, the decrease in the angle of incidence due to the increase in forward velocity is counteracted by the increase in the angle of incidence due to an increase in the blade pitch of the propeller blade 130.

In various embodiments, the magnitude in the change in blade pitch to counteract the effects of an increase in front wind may be dependent on the blade geometry. As one specific example, a smaller propeller blade 130 may increase the blade pitch from 20 degrees at rest up to 35 degrees in flight in order to counteract the effects of the increased front wind. Alternatively, a larger propeller blade 130 may increase the blade pitch from 12 degrees at rest up to 40 degrees in flight in order to counteract the effects of the increased front wind.

As another example, as an aerial vehicle is decreasing in forward velocity (e.g., braking), the body of the aerial vehicle may be oriented backward (e.g., upward relative to the horizon). In this scenario, the front wind on the propeller blade 130 may be acting in the same direction of a component of the thrust force 210 or opposite of the thrust force 210 itself. Therefore, the front wind increases the thrust force 210 relative to the centrifugal force 230, thereby enabling the propeller blade 130 to rotate clockwise (e.g., due to a larger thrust force 210) and decrease the blade pitch.

In various embodiments, as the aerial vehicle decreases forward velocity, the front wind experienced by the aerial vehicle (and propeller blades 130) decreases. The propeller blades 130 may operate in an opposite fashion relative to the description above when the aerial vehicle was increasing in forward velocity. Specifically, as the front wind decreases, this may cause a corresponding increase in the angle of incidence. Therefore, the blade pitch of the propeller blade 130 is decreased to counteract the effects on the angle of incidence caused by the decreasing front wind.

### Adjusting the Torque Balance Due to Changes in Environmental Conditions

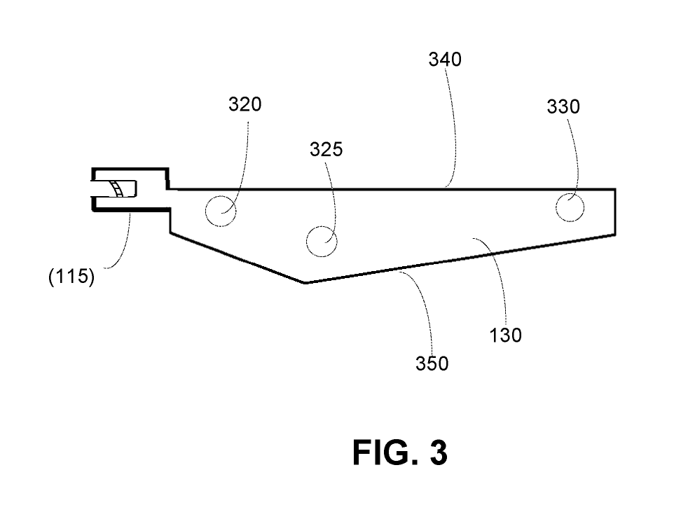

FIG. 3 illustrates a top-down view of a blade 130 with counterweights, in accordance with an example embodiment. The counterweights 320, 325, and 330 alter the moment of inertia of the blade 130. As previously described, the centrifugal force 230 is directed away from the rotor hub 150 which translates to a counter-clockwise rotation of the blade 130 (e.g., increasing blade pitch) relative to the rotor hub 150. However, the counter-clockwise rotation of the blade 130 is dependent on the moment of inertia of the blade 130. Therefore, the torque deriving from the centrifugal force 230 may be increased through the addition of the counterweights 320, 325, and 330. The location of each counterweight 320, 325, and 330 may affect the overall moment of inertia of the blade 130. For example, the farther a counterweight is located from the rotor hub 150 (assuming equally sized counterweights), the larger the increase in the moment of inertia of the blade 130. Referring to FIG. 3, counterweight 330 may increase the moment of inertia of the blade 130 more in comparison to the effects of counterweight 320.

Having control over the counter-clockwise rotation of the blade 130 due to the centrifugal force 230 is important in different environmental conditions. For example, in hot, humid, or high elevation environments, the generated thrust 210 on a blade 130 is lower because of a lower density of air molecules in the environment. Given that the centrifugal force 230 does not depend on density of air molecules, the torque balance on the blade 130 from the generated thrust 210 and centrifugal force 230 may be unbalanced. Therefore, to compensate for the change in torque from changes in the generated thrust 210 due to varying environmental conditions, counterweights 320, 325, and/or 330 may be added or removed to adjust the moment of inertia of the propeller blade 130. As shown in FIG. 3, these counterweights 320, 325, and 330 can be added along the length of the blade 130.

In various embodiments, the counterweights 320, 325, and 330 may be placed at any location on the blade. These locations may be predetermined. For example, the circular counterweights 320 depicted in FIG. 3 may reside in a reciprocal cavity on the blade 130 that have been preset. In other embodiments, the counterweight 320 may be affixed or attached to the blade 130 on either the top or bottom surface of the blade 130 at any location.

### Altering the Blade Pitch

FIG. 4A illustrates the blade connector 115 coupled with the extension 160 of the rotor hub 150 at rest, in accordance with an example embodiment. The extension 160 of the rotor hub 150 may include a channel path 110 and one or more detents 410. Optionally, a spring 420 may be coupled between the extension 160 of the rotor hub 420 and an optional block 430 of the connector 115. In various example embodiments, the connector 115 may be coupled to the extension 160 of the rotor hub 150 through only the channel path 110 (e.g., no detent 410 or spring 420). In other example embodiments, the channel path 110 is included along with one of the detent 410 or the spring 420.

The extension 160 may have a single channel path 110 that the connector 115 is coupled to. The ends of the channel path 110 define the maximum and minimum rotation of the connector 115. Additionally, the extension 160 may have one or more detents 410 that prevent the connector 115 from laterally decoupling with the extension 160. The connector 115 is at a second end 114 of the channel path 110 that positions the blade at its minimum blade pitch. To better illustrate this, FIG. 4B depicts the corresponding airfoil cross-section 260 at rest, in accordance with an example embodiment. The blade pitch φ 470 is minimized in this scenario as the connector 115 is located at the second end 114 of the channel path 110. In various embodiments, this second end 114 of the channel path 110 is the most proximal location of the channel path 110 to the rotor hub 150 in comparison to any other portion of the channel path 110. In various embodiments, such as the embodiment shown in FIG. 4A, the channel path 110 may be located on a portion of the surface of the extension 160. For example, FIG. 4A may depict a side view of the extension 160 and the connector 115. Therefore, the channel path 110 may be located on a side surface (e.g., left side surface) of the extension 160 as opposed to a top or bottom surface of the extension 160.

FIG. 4C illustrates the blade connector 115 coupled with the extension 160 of the rotor hub 150 while in-flight, in accordance with an example embodiment. In this embodiment, the clockwise torque applied by the generated thrust 210 (due to the reducing effects of a front wind) is smaller than the opposite torque derived from the centrifugal force 230. Therefore, the connector 115 rotates counter-clockwise along the channel path 110 to a first end 112. In various embodiments, this first end 112 is where the channel path 110 terminates and therefore, represents the farthest rotation that the connector 115 may rotate to. Here, the first end 112 represents the most distal location of the channel path 110 to the rotor hub 150 in comparison to other portions of the channel path 110. FIG. 4D depicts the corresponding airfoil cross-section 260 in this scenario, in accordance with an example embodiment. Here, the blade pitch is significantly increased to φ′ 475.

Optionally, the spring 420 is configured to return the blade 130 to its original blade pitch. For example, at resting position, the resting spring 420 is neither compressed nor stretched (as depicted in FIG. 4A). When in-flight, as shown in FIG. 4C, the spring 420 is in tension, held between the extension 160 of the rotor hub 150 and the block 430 of connector 115. As the propeller blade 130 decreases its rotational velocity, the spring 420 may revert back to its resting state as illustrated in FIG. 4A, thereby causing the connector 115 to rotate back along the channel path 110 to an initial resting position at the second end 114. Thus, the blade pitch will be restored to the initial blade pitch value φ 470.

In various embodiments, characteristics of the spring 420, such as the spring constant of the spring 420, can be chosen to enable the balance in torques between the torque derived from the generated thrust 210 on the blade 130 and the torque derived from the centrifugal force 230 on the blade 210. For example, the spring 420 may be at rest in the initial position shown in FIG. 4A (e.g., the connector 115 is coupled with the first end 112 of the channel path 110. In other words, the spring 420 may oppose any displacement that forces the spring 420 away from the initial position. For example, during flight, the spring 420 may be in tension (e.g., see FIG. 4C) and therefore, the spring 420 may oppose any further counter-clockwise torque on the blade 130 derived from the centrifugal force 230. Additionally, while in flight, the spring 420 may aid the clockwise torque on the blade 130 derived from the thrust force 210. Therefore, in various embodiments, the spring constant of the spring 420 can be selected such that the torque balance between the centrifugal force 230 and the generated thrust 210 remains a constant ratio as the propeller blade 130 increases and/or decreases in rotational velocity.

FIGS. 5A and 5B illustrate a cross-sectional view of a ball bearing connector 115 and the extension 160, in accordance with an example embodiment. This example embodiment shows one or more ball bearings 550 that may fix the maximum and minimum limits of angular rotation of the connector 115 relative to the extension 160. In various embodiments, this ball bearing connector 115 is implemented along the channel path 110 on the extension 160. In other words, the ball bearing 550 can be guided by the channel path 110 on the extension 160 to roll along a surface 560 of the extension 160.

The extension 160 may be designed such that a protrusion 570 of the extension 160 prevents the ball bearing 550 from rolling any further in a particular direction. On the other hand, the ball bearing 550 is free to roll along a surface 560 of the extension 160. The ball bearing 550 may be coupled to a reciprocal cavity 580 of the connector 115. Therefore, a clockwise rotation of the connector 115 will cause a corresponding clockwise movement of the ball bearing 550 along the surface 560 of the extension 160. For example, FIG. 5A illustrates the cross-section view of the connector 115 and extension 160 at a resting state. As the connector 115 rotates, the connector 115 may cause the ball bearings 550 to roll along the surface 560 of the extension 160. FIG. 5B illustrates the same cross-sectional view of the connector 115 and extension 160 when high quantities of generated thrust 210 is applied to the blade 130. Here, the ball bearings 550 have rolled to a second protrusion 575 of the extension 160. Accordingly, the reciprocal cavity 580 of the connector 115 (and the blade 130) is rotated to achieve a minimal blade pitch.

### Reducing Blade Pitch Oscillation

The blade pitch of a blade 130 often oscillates during in-flight conditions. For example, assuming that an aerial vehicle, is flying with a horizontal velocity, the blade pitch of a blade 130 may vary depending on whether the rotating blade is traveling forward in the same direction as the aerial vehicle or in the opposite direction of the aerial vehicle. For example, the blade 130 may oscillate due to external forces such as forces from the incoming front-wind. Therefore, those oscillations may be transferred to the connector 115 and cause lateral or vertical movement of the connector 115 relative to the extension 160. Overall, the blade pitch may be altered. Therefore, current embodiments disclosed herein reduce the oscillation of the blade pitch through a dampening mechanism, e.g., a mechanical dampener, in the connector 115.

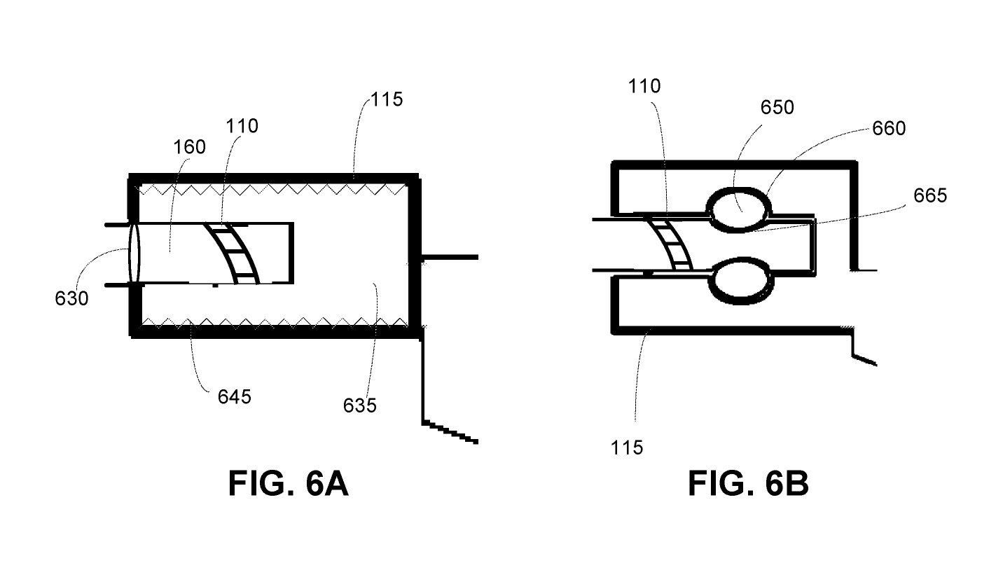

FIG. 6A illustrate a fluid filled connector 115, in accordance with an example embodiment. In various embodiments, the connector 115 contains a fluid 635 within a self-contained chamber. The self-contained chamber of the connector 115 is sealed off from the surrounding environment. For example, an O-ring seal 630 may seal the surface between the connector 115 and the extension 160 to prevent any fluid 635 from leaking to the exterior. In various embodiments, the fluid 635 may be a brake fluid, thereby providing a dampening mechanism to reduce the oscillations that the connector 115 may experience relative to the extension 160. In various other embodiments, the fluid 635 may be a hydraulic fluid or high viscosity fluid. Additionally, within the self-contained chamber, the connector 115 is coupled to the extension 160 of the rotor hub 150 through the channel path 110 located on the extension 160.

In various embodiments, the connector 115 may have further designs within the self-contained chamber to increase the dampening effect of the fluid 635. For example, there may be protrusions 645 along the sides of the self-contained chamber that increases the surface area in which the fluid 635 is in contact with.

FIG. 6B illustrates a top view of a ball bearing connector, in accordance with an example embodiment. In various embodiments, the connector 115 may remain coupled to the extension 160 through the channel path 110 on the extension 160. The connector 115 may contain a cavity 660 for receiving a ball bearing 650. Similarly, the extension 160 of the rotor hub 150 possesses a reciprocal cavity 665 to receive the same ball bearing 650. The ball bearings 650 may serve to limit the lateral movement of the connector 115 to prevent the connector from decoupling with the extension 160. Additionally, the ball bearings 650 may dampen oscillatory movements. For example, the ball bearings may be designed to receive and absorb the oscillatory movement of the connector 115.

### ADDITIONAL EMBODIMENT CONSIDERATIONS

The disclosed embodiments of the variable pitch propeller provide advantages over conventional propellers. For example, the pitch of the blade may be optimized for all in-flight conditions. In doing so, the efficiency of the blade, and in turn the overall propeller, is improved and overall power consumption may be reduced. Moreover, these benefits are further enhanced on quadcopters where four propellers are engaged. Reducing power consumption may provide benefits such as extending battery life in the quadcopter, thereby increasing flight time, and/or requiring smaller battery sizes, thereby reducing overall weight of the quadcopter.

Additionally, conventional blades are typically controlled through human intervention by means of a mechanical swashplate. To optimize the blade pitch during in-flight conditions, the individual must have training in aerodynamics to understand how to adjust the mechanical swashplate to achieve a particular blade pitch. Even so, human intervention often results in human and/or mechanical error. The current embodiment may optimize the blade pitch for in-flight conditions without the need for human intervention by relying on the torque balance generated by the generated thrust and centrifugal force on the blade.

Finally, the disclosed embodiments of the variable pitch blade may be employed for larger blade sizes. Larger blades are significantly more efficient as they can generate higher levels of thrust at a particular rotational speed as compared to smaller blades. However, larger blades are significantly more sensitive to wind forces and thus, cannot be implemented as a fixed pitch blade. This variable pitch blade, as disclosed herein, enables the use of larger, more efficiently designed propeller blades for aerial vehicles.

Throughout this specification, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Upon reading this disclosure, those of skilled in the art will appreciate still additional alternative structural and functional designs for variable pitch blades as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement and details of the apparatus disclosed herein without departing from the spirit and scope defined in the appended claims.

What is claimed is:

1. A variable pitch propeller comprising:
a propeller blade comprising a connector coupled to one end of a body of the propeller blade, the connector and the body of the propeller blade offset from one another by an offset distance; and
a rotor hub comprising an extension having a channel path located on a surface of the extension,
wherein the connector is further rotatably coupled to the rotor hub through the channel path of the extension.

2. The variable pitch propeller of claim 1, wherein the channel path resides on a portion of the surface of the extension without traversing the full perimeter of the extension.

3. The variable pitch propeller of claim 1, wherein the propeller blade has a first blade pitch when the connector is rotatably coupled to a first end of the channel path and wherein the propeller blade has a second blade pitch when the connector is rotatably coupled to a second end of the channel path, wherein the first blade pitch is larger in comparison to the second blade pitch.

4. The variable pitch propeller of claim 3, wherein the first end of the channel path and the second end of the channel path are defined by detents located on the extension of the rotor hub.

5. The variable pitch propeller of claim 3, wherein the first end of the channel path is located distal to the rotor hub in comparison to the second end of the channel path.

6. The variable pitch propeller of claim 3, wherein the channel path directs the connector of the propeller blade towards the first end of the channel path based on a balance of torques on the propeller blade.

7. The variable pitch propeller of claim 6, wherein the balance of torques comprises a torque on the body of the propeller blade generated by a thrust force and an opposite torque on the body of the propeller blade generated by a centrifugal force.

8. The variable pitch propeller of claim 1, wherein the propeller blade further comprises one or more counterweights located along a length of the propeller blade.

9. A variable pitch propeller comprising:
a propeller blade comprising a connector coupled to a first end of a body of the propeller blade; and
a rotor hub comprising an extension comprising:
a channel path located on a surface of the extension;
one or more detents that prevent the connector of the propeller blade from laterally decoupling from the extension; and
a spring, wherein a first end of the spring is coupled to the extension of the rotor hub and a second end of the spring is coupled to the connector of the propeller blade,
wherein the connector is rotatably coupled to the rotor hub through the channel path of the extension.

10. The variable pitch propeller of claim 9, wherein the propeller blade has a first blade pitch when the connector is rotatably coupled to a first end of the channel path and wherein the propeller blade has a second blade pitch when the connector is rotatably coupled to a second end of the channel path, wherein the first blade pitch is larger in comparison to the second blade pitch.

11. The variable pitch propeller of claim 10, wherein the first end of the channel path is located distal to the rotor hub in comparison to the second end of the channel path.

12. The variable pitch propeller of claim 10, wherein the channel path directs the connector of the propeller blade towards the first end of the channel path based on a balance of torques on the propeller blade.

13. The variable pitch propeller of claim 9, wherein the spring returns the connector of the propeller blade to couple with a second end of the channel path.

14. The variable pitch propeller of claim 9, wherein during flight, the spring opposes a torque on the body of the propeller blade generated by a centrifugal force and aids an opposite torque on the body of the propeller blade generated by a thrust force

15. A variable pitch propeller comprising:
a propeller blade comprising a connector coupled to one end of a body of the propeller blade, the connector further comprising:
a dampener configured to minimize an oscillation of a blade pitch of the propeller blade; and
a rotor hub comprising an extension having a channel path located on a surface of the extension,
wherein the connector is rotatably coupled to the rotor hub through the channel path of the extension.

16. The variable pitch propeller of claim 15, wherein the propeller blade has a first blade pitch when the connector is rotatably coupled to a first end of the channel path and wherein the propeller blade has a second blade pitch when the connector is rotatably coupled to a second end of the channel path, wherein the first blade pitch is larger in comparison to the second blade pitch.

17. The variable pitch propeller of claim 16, wherein the first end of the channel path is located distal to the rotor hub in comparison to the second end of the channel path.

18. The variable pitch propeller of claim 16, wherein the channel path directs the connector of the propeller blade towards the first end of the channel path based on a balance of torques on the propeller blade.

19. The variable pitch propeller of claim 15, wherein the dampener of the connector comprises a self-contained chamber containing a fluid sealed in the self-contained chamber.

20. The variable pitch propeller of claim 15, wherein the dampener of the connector comprises one or more ball bearings configured to receive the oscillatory movement of the connector of the blade.
